(19) United States
(12) Patent Application Publication
(10) Pub. No.: US 2013/0342678 A1
(43) Pub. Date: Dec. 26, 2013

(54) VISUAL MONITORING, OR IMAGING, SYSTEM AND METHOD FOR USING SAME

(71) Applicants: Michael D McANINCH, GOODE, VA (US); Troy D PASKELL, POWELL, OH (US); Jeffrey A MABEE, MARYSVILLE, OH (US); Thomas E DOYLE, LOUISVILLE, OH (US); Darren M BARBORAK, DULUTH, GA (US)

(72) Inventors: Michael D McANINCH, GOODE, VA (US); Troy D PASKELL, POWELL, OH (US); Jeffrey A MABEE, MARYSVILLE, OH (US); Thomas E DOYLE, LOUISVILLE, OH (US); Darren M BARBORAK, DULUTH, GA (US)

(21) Appl. No.: 13/921,300

(22) Filed: Jun. 19, 2013

Related U.S. Application Data
(60) Provisional application No. 61/664,593, filed on Jun. 26, 2012.

(51) Int. Cl. B23K 31/12

(52) U.S. Cl. CPC B23K 31/125
USPC 348/90; 348/143

(57) ABSTRACT

The present invention relates generally to both a system and method for visually (e.g., via a video-based system or some other visual system) monitoring one or more objects where such objects are obscured by a high intensity light source such as a plasma, flame, or welding arc. In one embodiment, a system in accordance with the present invention comprises a digital camera, at least one light emitting diode (LED) light source, and at least one filter. In another embodiment, a system in accordance with the present invention comprises a digital camera, at least one light emitting diode (LED) light source, and at least one filter selected from a notch filter, a neutral density filter, or combinations thereof. Additionally, the system of the present invention can further include software designed to process, interpret and/or collect various data captured by the visual monitoring, or, imaging, system of the present invention.

### RELATED APPLICATION DATA

This patent application claims priority to U.S. Provisional Patent Application No. 61/664,593 filed Jun. 26, 2012 and titled “Visual Monitoring, or Imaging, System and Method for Using Same.” The complete text of this application is hereby incorporated by reference as though fully set forth herein in its entirety.

### FIELD AND BACKGROUND OF THE INVENTION

1. Field of the Invention

The present invention relates generally to both a system and method for visually (e.g., via a video-based system or some other visual system) monitoring one or more objects where such objects are obscured by a high intensity light source such as a plasma, flame, or welding arc. In one embodiment, a system in accordance with the present invention comprises a digital camera, at least one light emitting diode (LED) light source, and at least one filter. In another embodiment, a system in accordance with the present invention comprises a digital camera, at least one light emitting diode (LED) light source, and at least one filter selected from a notch filter, a neutral density filter, or combinations thereof. Additionally, the system of the present invention can further include software designed to process, interpret and/or collect various data captured by the visual monitoring, or, imaging, system of the present invention.

2. Description of the Related Art

In both manual and automatic welding, welding quality can be improved by real-time sensory information about a variety of weld site parameters, including diameter and depth of the molten welding pool, temperature gradients around the pool, position of the pool versus the welding seam or previous weld beads, contamination or slag in the welding pool, and the degree of wetting at the weld pool/solidus interface. These parameters and others are often observed or inferred in the manual and automatic welding processes, primarily by means of either the welder's vision or by the intensity of the light generated by the welding process.

A variety of sensory techniques have been used in automatic welding as a replacement for the manual welder's vision. However, as the trend continues towards machine or automatic welding (free from operator or welder intervention), a welder's vision cannot be replaced but must instead be duplicated to some degree by the use of electronic vision, one or more computers, and/or image processing software. This approach can sometimes involve the use of a miniature video camera or solid-state optical detector array and appropriate optics which must be carefully integrated into the design of the welding torch.

U.S. Pat. No. 4,649,426 is directed to an imaging system for viewing objects obscured by intense plasma or flames (such as a welding arc) during the course of operation (see FIG. 1). As disclosed therein, the system of U.S. Pat. No. 4,649,426 comprises a pulsed laser or xenon light source used to illuminate the object where the peak brightness of the light source is greater than the brightness of the plasma or flame; an electronic image sensor for detecting a pulsed image of the illuminated object, the sensor being operated as a high-speed shutter; and electronic means for synchronizing the shutter operation with the pulsed light source.

The system of U.S. Pat. No. 4,649,426 is based upon the premise that in the case of welding, the welding arc light in the form of an intense plasma, or flame, must be greatly suppressed and/or replaced by external illumination from a short-arc flash lamp or laser (see FIG. 2). The illuminated image is displayed on an electronic imaging sensor such as an intensifier tube, or using a semiconductor integrated circuit imaging device.

In the system and method disclosed in U.S. Pat. No. 4,649,426, displaying an image of the object is accomplished by pulsing the light source in synchronization with a shutter on the imaging device such that the imaging device is only looking at the object while it is being illuminated by the light source (see FIG. 3). The light source is of such intensity that it over-powers the light intensity of the plasma, or flame, being used to complete the welding process. A Fresnel lens is used to further focus the light source to maximize the peak power intensity of the light to assure that the peak power density of the light source is higher than the light emitted by object to be viewed due to it being subjected to a welding process.

In the system and method disclosed in U.S. Pat. No. 4,649,426, the synchronization of the camera shutter with the pulsing of the xenon or laser light source results in a system which preferentially accepts light originating from the high intensity pulsed light source, but strongly discriminates against the steady state light coming from the plasma or flame (see FIG. 3). The instantaneous brightness of the welding arc light is exceeded by the peak brightness of the pulsed light source. This ensures that the resulting video image will contain only a small component of light from the arc, or plasma, being used in the welding process. Neutral density filters are used to reduce the overall light level and improve the contrast of the video image.

Another example of a system and/or method designed to monitor a welding process that generates a high intensity light source is General Electric's Weldvision System. This system is designed for the gas-tungsten arc welding process (GTAW) in which a tungsten electrode is used to create the arc and the electrode and weld site are protected from oxidation by use of an inert purge gas. The vertical electrode is enclosed by a tubular shroud (or “gas cup”) and the purge gas flows through the shroud from above and onto the welding site. The General Electric system comprises an optical system coaxial with the electrode to acquire an image, which in turn is relayed by a fiber optic bundle to a small solid-state CID video camera.

The viewing geometry utilized by the General Electric system is attractive, first, because it provides a direct overhead perspective of the entire welding pool and, secondly, because the welding electrode provides blockage of light from the brightest portion of the welding arc and thereby improves the quality of the video image. The General Electric system is used primarily to obtain video data describing weld pool diameter and position relative to the prepared welding groove. The groove location is revealed by two parallel laser stripes beamed onto the weld joint in advance of the welding pool. Although the General Electric system accomplishes true automatic welding, it is limited to single-pass welding because the guidance signature from the groove is destroyed during the first welding pass.

Another welding process, important for its use in heavy construction, is gas-metal arc welding (GMAW). The GMAW process is similar to GTAW, however, the tungsten electrode is replaced by a consumable wire electrode, which provides the filler material for the weld. This process applies metal at higher rates at less power, but creates a greater threat to optical components, with much higher levels of spattering metal.

U.S. Pat. No. 4,868,649 discloses an apparatus for televisual monitoring of an arc welding operation. In the system of U.S. Pat. No. 4,868,649, viewing of the welding arc is accomplished by the use of a variable transmission neutral density filter comprised of a ceramic material having light rotatory properties and electrodes in contact with the ceramic plate whereby the electrodes are used to regulate the apparent neutral density of the filter and can be designed such that the density of the filter can be set at different levels (for different zones on the ceramic plate) based upon the grid network of the electrodes (see FIGS. 4 and 5).

FIG. 4 shows a video camera 10 of the system of U.S. Pat. No. 4,868,649 which has an inlet window 15 directed towards the bottom of the bevel 3 (direction of the arrow 14) when the camera is mounted in the operating position on the welding machine. At its other end, the camera has an outlet for a video cable 13 enabling the video signal to be transmitted to the electronic unit casing, which in turn is connected to the control station of the welding plant by a video cable 16. Between the inlet window 15 and the video signal outlet 13, the camera contains in conventional manner a set of filters 17, 18, 19, a light beam return prism 21, an objective 20, and a miniaturized electro-optical circuit 22 in the form of an electronic chip. The video signal obtained at the output of the circuit 22 is transmitted by the cables 13 and 16 to the control station for the reconstruction of the image on the television screen.

According to U.S. Pat. No. 4,868,649, an additional filter 24 is interposed between the objective 20 and the circuit supplying the video signal 22. The filter 24 is held in position on the camera by an assembly 25 comprising a bow, screws and support springs.

FIG. 5 shows the filter 24 of the video camera of U.S. Pat. No. 4,868,649, where the filter 24 is composed of a plate of ceramic material having light rotatory properties sensitive to the action of an electric field in the material of the ceramic plate 24. The square plate 24 has sides of a length of 25.4 millimeters and a thickness of 0.3 millimeter. Four rectilinear electrodes 26a, 26b, 26c and 26d are brought into contact with one of the faces of the ceramic plate 24 directed towards the objective 20, in the central part of said plate. Four other electrodes 27a, 27b, 27c and 27d are brought into contact with the other face of the ceramic plate 24, directed towards the electronic circuit 22, in the central part of said plate. The electrodes 27a, 27b, 27c and 27d are at right angles to the electrodes 26a, 26b, 26c, 26d and have branches parallel to the latter. The electrodes are formed by deposition of a layer of chromium of a thickness less than 50 μm and width of 60 μm on the faces of the plate 24. The ends of the electrodes intended to be joined to the control circuit by conductors are covered with gold.

In FIG. 5, the dotted lines indicate a square 29 situated at the center of this zone covered by the electrodes, the sides of this square measuring less than 10 millimeters. Square 29 corresponds to the inlet window of the optoelectronic circuit 22. This active zone of the filter, traversed by the light rays leaving the objective and originating from the welding zone, is divided into sixteen substantially square zones 30, each corresponding to the intercrossing of two electrodes situated one on each side of the plate 24 constituting the filter. When the electrodes 26 and 27 are fed at different potentials, electric fields pass through the plate 24 in the direction of its thickness. Electric fields can be regulated to desirable values, in each of the elementary zones 30, by adjusting the potentials of the corresponding electrodes 26 and 27.

These electrode potentials are adjusted by means of the electronic unit disposed inside the casing, which is connected to the camera by a connection cable 13. The control of the electrodes is the result of the analysis of the video signal passing out of the circuit 22, and permits adjustment of the electric fields in such a manner as to increase the optical density of the filter in certain zones, in order to reduce the brightness effect of the arc. The other zones 30 of the active part 29 of the filter 24 may simultaneously retain a low density and a low filtering power, the potentials of the corresponding electrodes being selected accordingly.

The ceramic material has in fact light rotatory properties dependent on the electrical field to which it is subjected, so that the control of the potential of the electrodes makes it possible to adjust the density of the filter in the different zones 30. As a general rule, the density of the filter will be adjusted to a higher value at the center of the active zone 29 than on the periphery, since the central part receives the rays originating from zones subjected directly to the light of the arc. The electronic unit casing contains an arrangement for analysis of the video signal coming from the optoelectronic circuit 22 and control of the potentials of the electrodes 26 and 27 situated one on each side of the ceramic plate 24 constituting the filter.

Another system and process for video monitoring a welding operation is disclosed in U.S. Pat. No. 4,918,517. The system of U.S. Pat. No. 4,918,517 is designed to visually monitor a welding process where an intense point of light is generated by the point source. The ability of the system U.S. Pat. No. 4,918,517 to view the welding process is based upon using a neutral density filter (or series of filters) where the central region of the filter(s) has a low transmission of light for dimming the image of the point source and the peripheral region of the filter(s) has a high transmission of light for freely transmitting the image of the area surrounding the welding arc. The filter/filter assembly is moved along the axis of the camera lens assembly to adjust the parent size of the central region of the filter(s) by moving them in and out of the focus range of the lens assembly.

Although the above systems are suitable for monitoring various welding processes that generate high intensity light sources, they all suffer from various drawbacks. The following drawbacks are non-limiting examples of the issues created by the systems of the prior art. As is known to those of skill in the art, a xenon flash lamp is a full spectrum light source while a laser source is generally a single wavelength source. As will be explained herein, both of these sources suffer from the drawback of being dangerous to operating personnel. For instance, a laser-based visually imaging system requires special shielding to protect the eyes and skin of the operator in order to prevent bodily damage. Additionally, any unplanned reflections of the laser beam must be accounted for and protected against to prevent safety issues. While not as dangerous as a laser, a xenon flash lamp also has several serious safety issues based on the intensity of the xenon flash lamp. For example, eye and skin protection are required in order to protect against exposure to the intense light source generated by the xenon flash lamp.

Given the above, a need exists in the art for a system and method that permits visual monitoring, or imaging, of one or more objects where such objects are obscured by a high intensity light source (e.g., a plasma, flame, or welding arc).

### SUMMARY OF THE INVENTION

The present invention relates generally to both a system and method for visually (e.g., via a video-based system or some other visual system) monitoring one or more objects where such objects are obscured by a high intensity light source such as a plasma, flame, or welding arc. In one embodiment, a system in accordance with the present invention comprises a digital camera, at least one light emitting diode (LED) light source, and at least one filter. In another embodiment, a system in accordance with the present invention comprises a digital camera, at least one light emitting diode (LED) light source, and at least one filter selected from a notch filter, a neutral density filter, or combinations thereof. Additionally, the system of the present invention can further include software designed to process, interpret and/or collect various data captured by the visual monitoring, or, imaging, system of the present invention.

Accordingly, one aspect of the present invention is drawn to a visual monitoring, or imaging, system comprising: at least one digital camera; at least one light emitting diode light source; and at least one filter, or multi-filter system.

In yet another aspect of the present invention, there is provided a method of imaging a work piece being subjected to an intense light source, the method comprising the step of: using a visual monitoring, or imaging, system comprising: at least one digital camera; at least one light emitting diode light source; and at least one filter, or multi-filter system to image a work piece being subjected to an intense light source.

In yet another aspect of the present invention, there is provided a visual monitoring, or imaging, system comprising: at least one digital camera; at least one light emitting diode light source; at least one filter, or multi-filter system; and image capturing, processing and/or collecting software.

In yet another aspect of the present invention, there is provided a method of imaging a work piece being subjected to an intense light source, the method comprising the step of: using a visual monitoring, or imaging, system comprising: at least one digital camera; at least one light emitting diode light source; at least one filter, or multi-filter system; and image capturing, processing and/or collecting software to image a work piece being subjected to an intense light source.

In yet another aspect of the present invention, there is provided a method a visual monitoring, or imaging, system comprising: at least one digital camera; at least one light emitting diode light source; at least one filter, or multi-filter system; and image capturing, processing and/or collecting software that utilizes, in part, individual pixel filtering.

In yet another aspect of the present invention, there is provided a method for visually monitoring, or imaging, a work piece using a visual monitoring, or imaging, system as shown and described herein.

In yet another aspect of the present invention, there is provided a method for visually monitoring, or imaging, a work piece as shown and described herein.

The various features of novelty which characterize the invention are pointed out with particularity in the claims annexed to and forming a part of this disclosure. For a better understanding of the invention, its operating advantages and specific benefits attained by its uses, reference is made to the accompanying drawings and descriptive matter in which exemplary embodiments of the invention are illustrated.

### BRIEF DESCRIPTION OF THE DRAWINGS

FIG. 1 is an illustration of an imaging system according to the prior art;

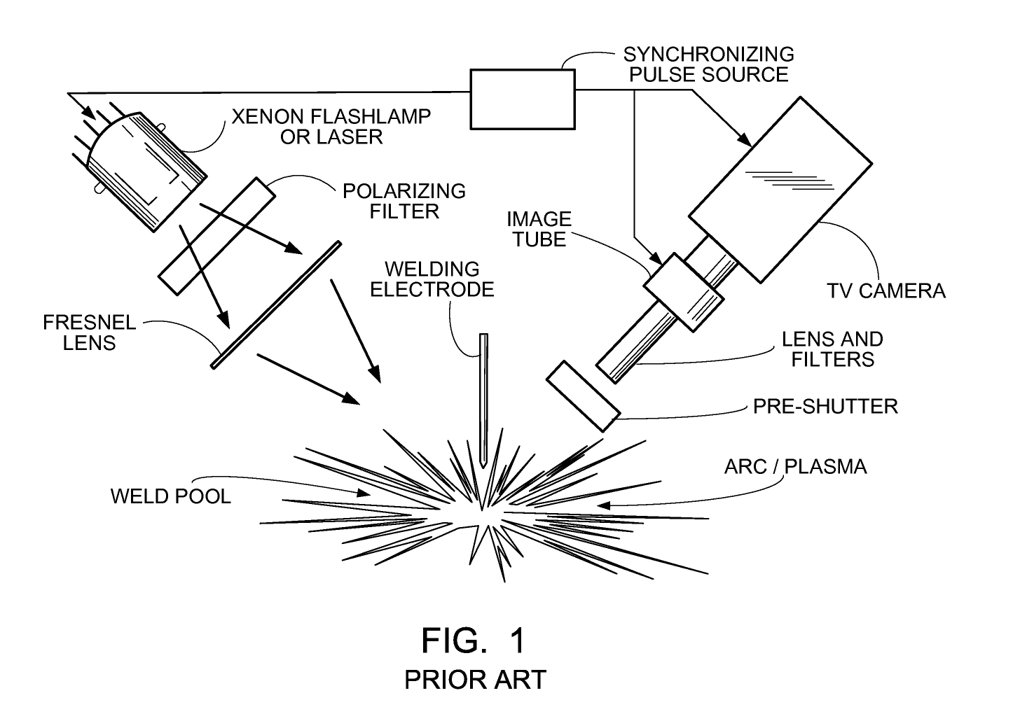

FIG. 2 is an illustration of the relative intensity of the light emitted from a xenon, or laser, light source as compared to the relative intensity of the light emitted from a welding operation;

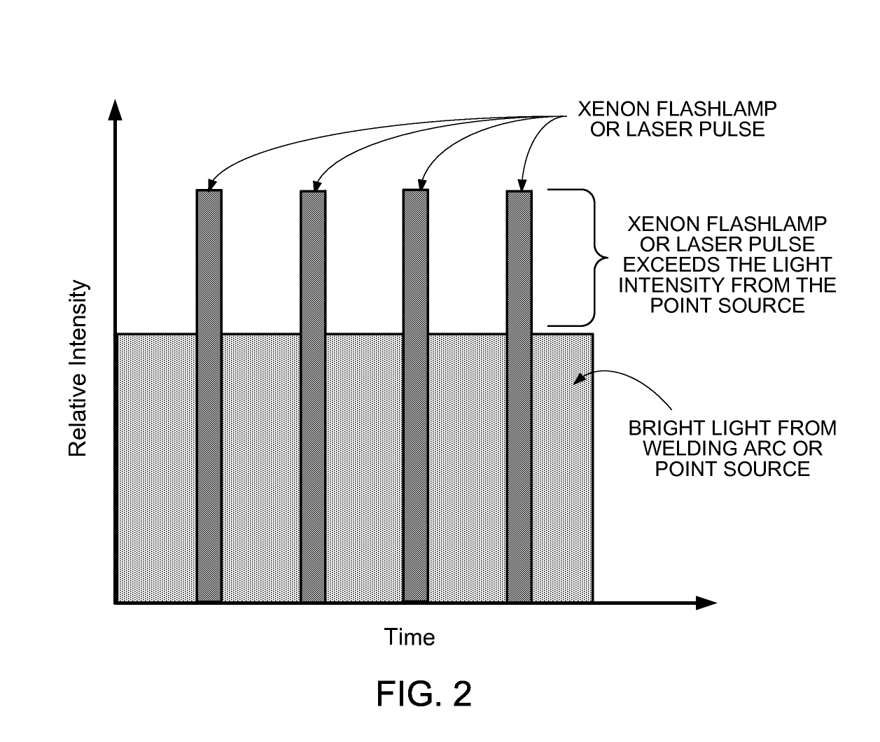

FIG. 3 is an illustration of the synchronization of the camera shutter with a pulsing of xenon flash lamps, or laser, to reduce the overall light reaching a camera;

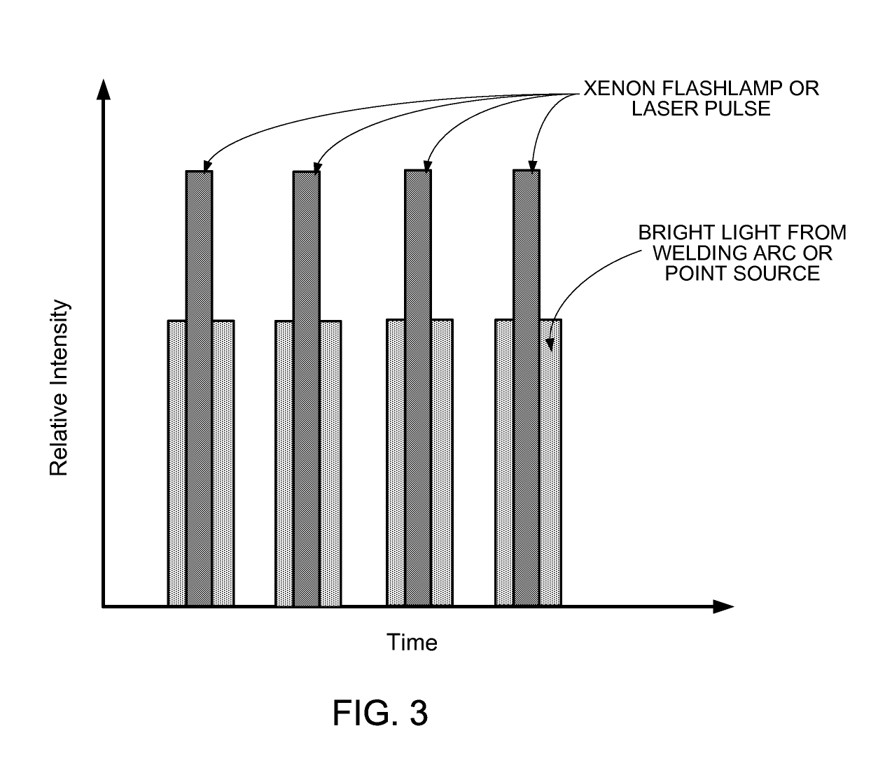

FIG. 4 is an illustration of a lens assembly that is utilized in an imaging system of the prior art;

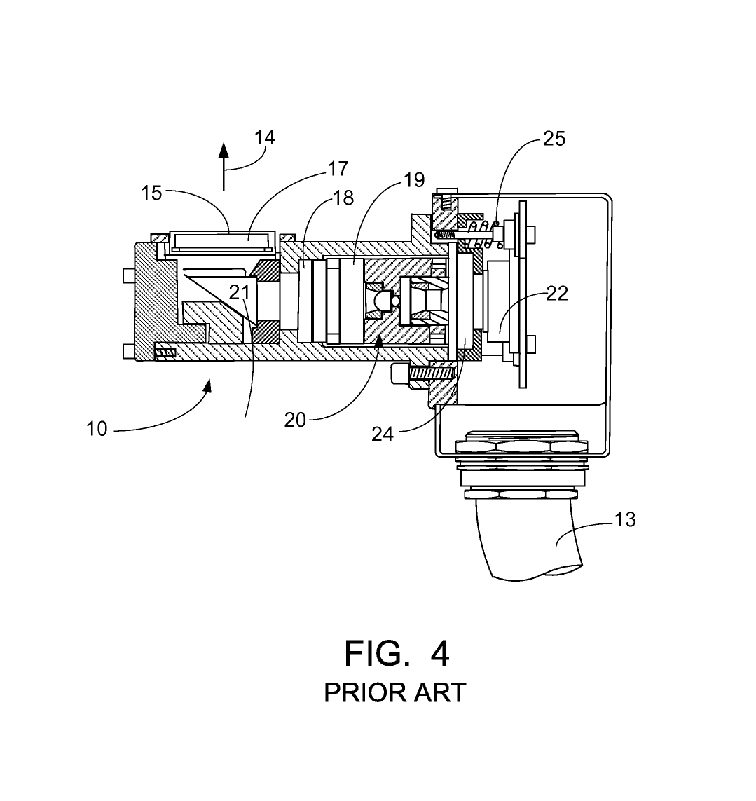

FIG. 5 is an illustration of a variable density ceramic that is used in an imaging system of the prior art;

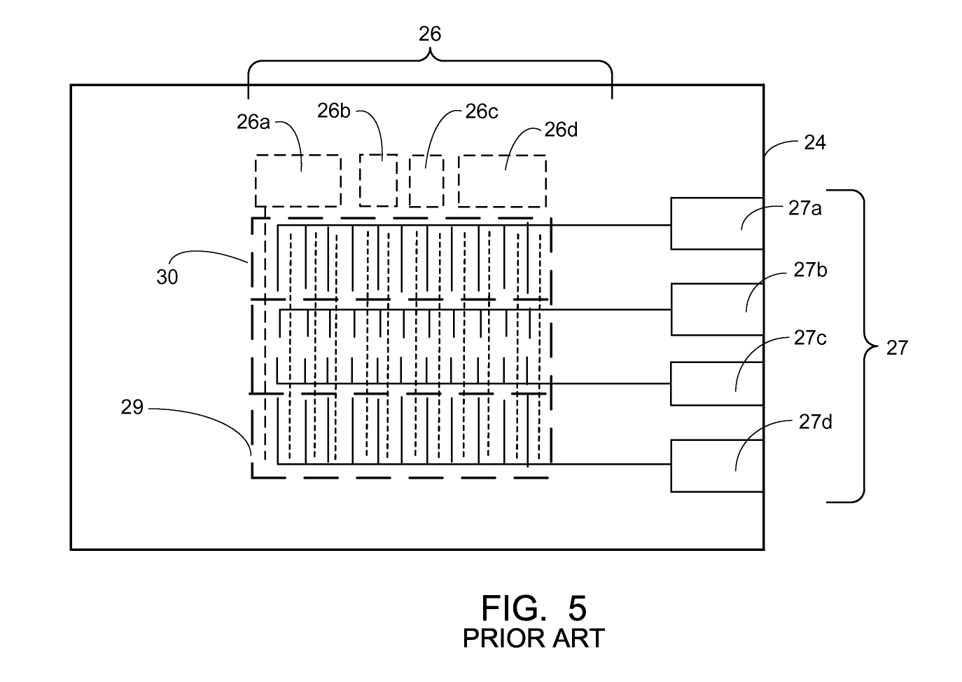

FIG. 6 is a spectral illustration of a typical light wavelength spectrum from a gas tungsten arc welding process using helium shielding with various peaks representing wavelengths with high light intensity;

FIG. 7 is a spectral illustration of various spectral regions of low intensity light emission (i.e., dark regions) form the exemplary welding arc spectrum of FIG. 6;

FIG. 8 is a spectral graph illustrating an exemplary spectra for blue, green, yellow and red LEDs (note there are additional wavelengths/colors of LEDs that are not displayed for clarity purposes in this Figure);

FIG. 9 is a chart illustrating a generalized listing of the spectra available for LEDs (note that within each color band there are additional subsets of spectra based upon the particular type of semiconductor material utilized);

FIG. 10 is a spectral illustration of an example of a red LED selected to coincide with a low intensity region (or “dark region”) of the arc spectrum shown in FIG. 7;

FIG. 11 is an illustration of example of a pulse synchronization between a camera shutter and LED lights (note that the LED lights are substantially lower in intensity as compared to the point source);

FIG. 12 is a photograph of a typical video image of a GTA welding operation using a Babcock & Wilcox/Weld Quality Control Camera;

FIG. 13 is a graph illustrating the light spectrum of a xenon flash lamp;

FIG. 14 is a plot illustrating the typical spectral bandwidth for a standard LED light source;

FIG. 15 is a plot illustrating numerous available LED bandwidths that can be selected based upon the spectral analysis for various specific viewing applications.

### DESCRIPTION OF THE INVENTION

While the present invention will be described in terms of a visual monitoring, or imaging, system and method for use in conjunction with a plasma welding process, flame-based welding process, or a welding arc process, the present invention is not limited thereto. Rather, the system and/or method of the present invention can be utilized in any situation where the need presents itself to visually monitor, or image, any process that is, or may be, obscured by a high intensity light source.

Thus, as stated above, the present invention relates generally to both a system and method for visually (e.g., via a video-based system or some other visual system) monitoring one or more objects where such objects are obscured by a high intensity light source such as a plasma, flame, or welding arc. In one embodiment, a system in accordance with the present invention comprises a digital camera, at least one light emitting diode (LED) light source, and at least one filter. In another embodiment, a system in accordance with the present invention comprises a digital camera, at least one light emitting diode (LED) light source, and at least one filter selected from a notch filter, a neutral density filter, or combinations thereof. Additionally, the system of the present invention can further include software designed to process, interpret and/or collect various data captured by the visual monitoring, or, imaging, system of the present invention.

In light of the above, one embodiment of the present invention comprises an visual monitoring, or imaging, system for viewing objects obscured by a high intensity light source (e.g., plasma, a flame, or a welding arc). The present invention overcomes various shortcomings of the prior art to yield a more capable, safer and more economical visual monitoring, or imaging, system. In one embodiment, the visual monitoring, or imaging, system of the present invention comprises a digital camera, one or more light emitting diode (LED) light sources, and at least one filter, or multi-filter scheme. The at least one filter, or at least one multi-filter scheme, can in one embodiment comprise at least one notch filter, at least one neutral density filter, or any combination of two or more thereof.

In another embodiment, the visual monitoring, or imaging, system of the present invention comprises a digital camera, one or more light emitting diode (LED) light sources, and at least one filter, or multi-filter scheme in combination with software that is designed to process, interpret and/or collect various data captured by the visual monitoring, or, imaging, system of the present invention. The at least one filter, or at least one multi-filter scheme, can in one embodiment comprise at least one notch filter, at least one neutral density filter, or any combination of two or more thereof, and software.

In one embodiment, the visual monitoring, or imaging, system utilizes a scheme of selective spectral lighting and filtering to permit visualization, or imaging, of an object that is obscured by an intense light source. The wavelength of light and its intensity emitted from a source can vary significantly and is dependent upon a number of factors. In the case of welding factors, factors to be considered include, but are not limited to, include the weld process type, atmospheric shielding gas type (i.e., such as argon, helium, etc.) and base and weld filler metal alloy type. The specific wavelength signature for a given application is measured using a spectral analyzer and this information is used to tailor the configuration of visual monitoring, or imaging, system according to the present invention.

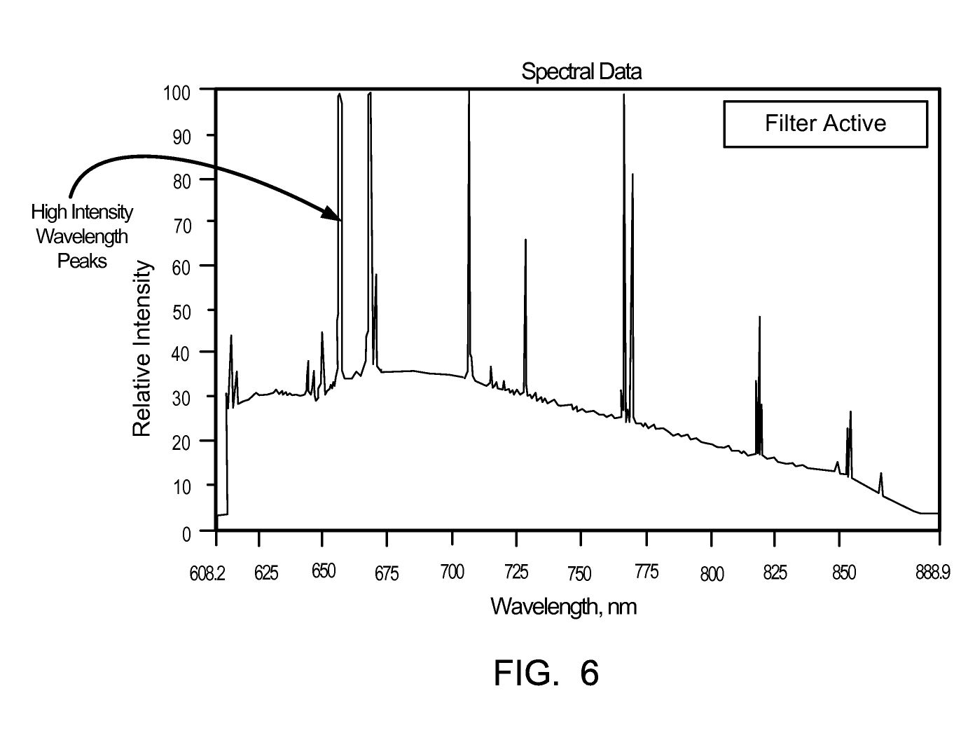

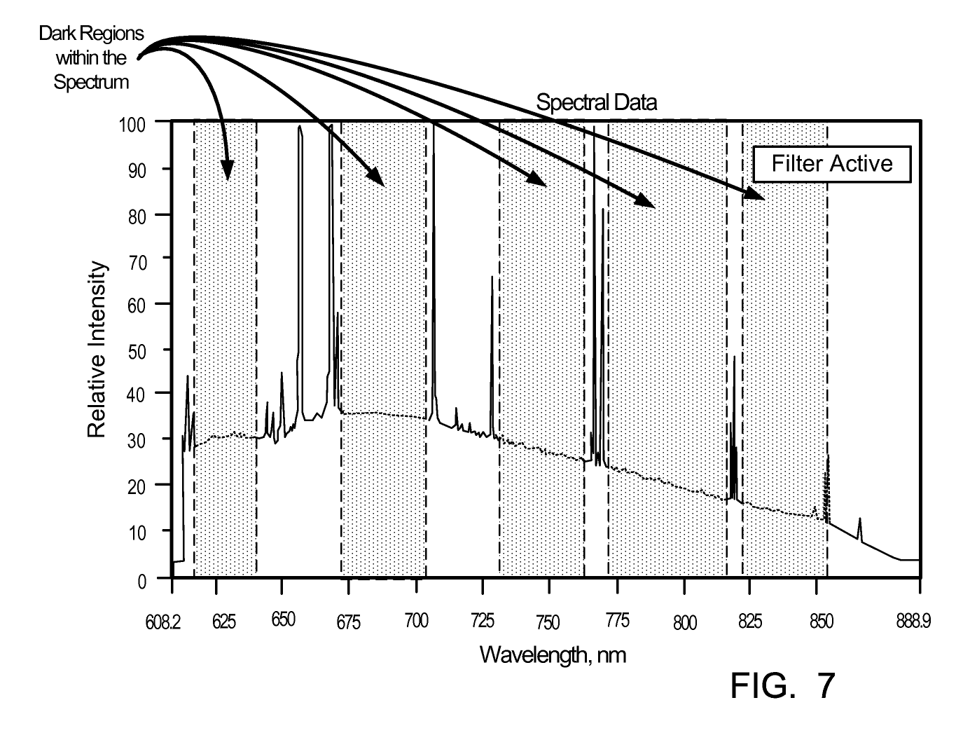

Given this, the present invention is not limited to any one specific layout, or orientation. Rather any suitable layout can be utilized so long as the visual monitoring, or imaging, system according to the present invention contains at a minimum the elements described above. FIG. 6 provides an illustration of a typical arc spectrum for gas tungsten arc welding. FIG. 7 is an illustration of various spectral regions of low intensity light emission (i.e., “dark regions”) form the exemplary welding arc spectrum of FIG. 6. Given this, the “dark regions” represent potential wavelength regions for the structured lighting-based portion of the visual monitoring, or imaging, system according to the present invention.

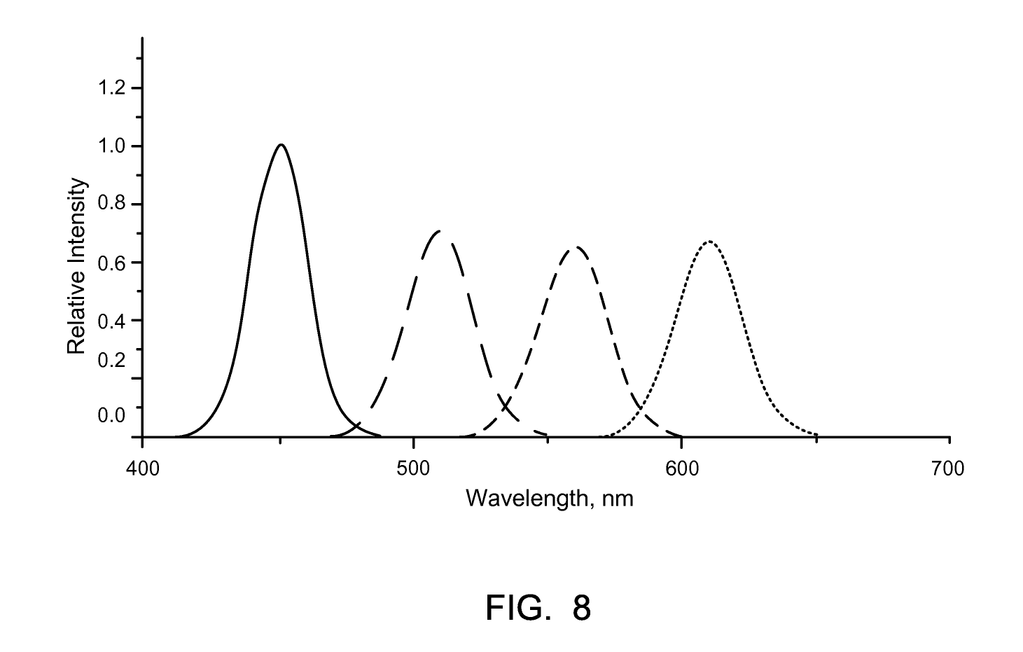

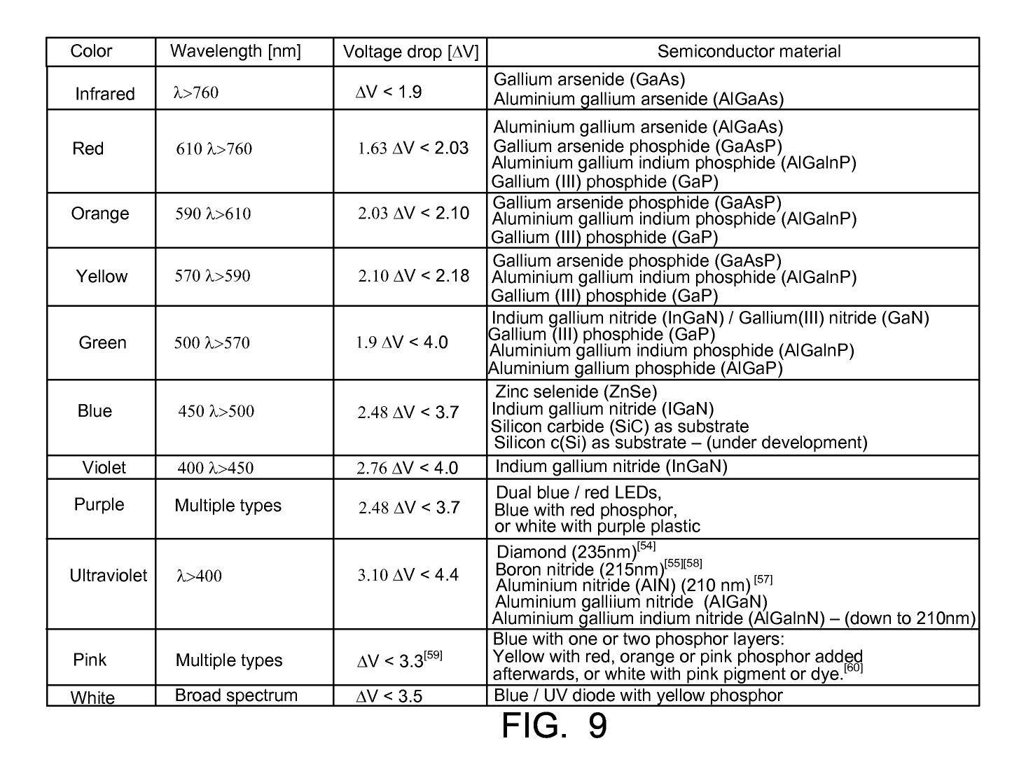

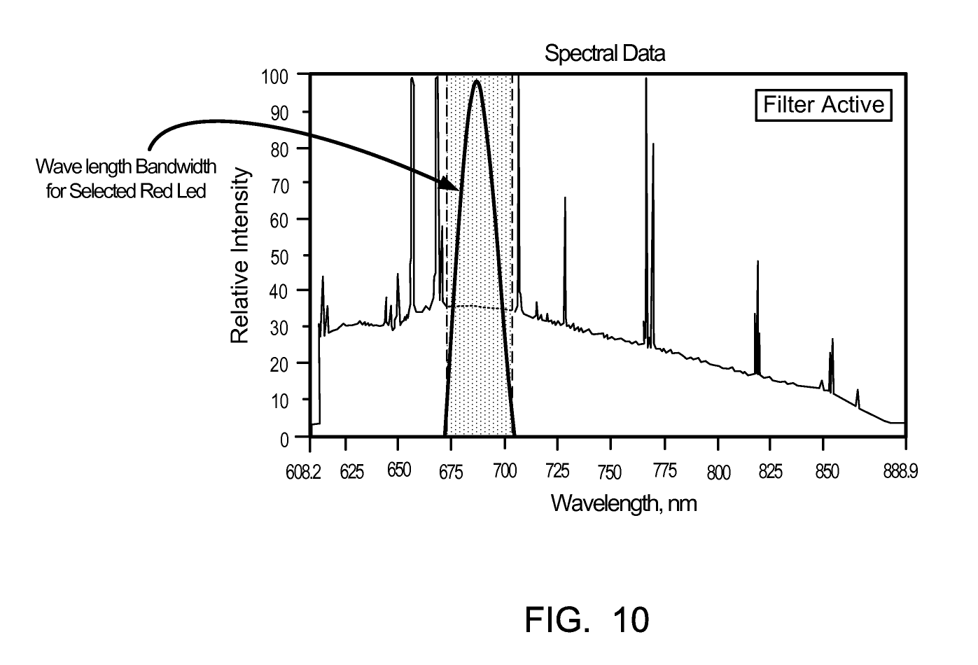

From the spectral analysis, several wavelength bands are identified which have low intensity and are defined herein as “dark regions” (see FIG. 7). These “dark regions,” or “dark spectral regions,” are compared to the wavelengths available for LEDs (see FIGS. 8 and 9). An LED wavelength that corresponds to a “dark region” of the spectrum is selected (see FIG. 10) as the structured lighting source. A wavelength notch filter is then selected that corresponds to the wavelength bandwidth emitted by the LED. In one embodiment, a notch filter is utilized to block all light except those wavelengths within the bandwidth of the filter from reaching the digital imaging camera. The auxiliary LED lights are positioned to illuminate the area surrounding the welding arc to provide an image of the surrounding structure. The lights are aligned such that the camera receives a maximum amount of light from the LED(s).

Thus given the above, the at least one light emitting diode of the present invention can be selected from at least one infrared light emitting diode, at least one red light emitting diode, at least one orange light emitting diode, at least one yellow light emitting diode, at least one green light emitting diode, at least one blue light emitting diode, at least one violet light emitting diode, at least purple light emitting diode, at least one ultraviolet light emitting diode, at least one pink light emitting diode, at least one white light emitting diode, or a combination of any two or more thereof, any three or more thereof, any four or more thereof, any five or more thereof, any six or more thereof, or even any seven or more thereof.

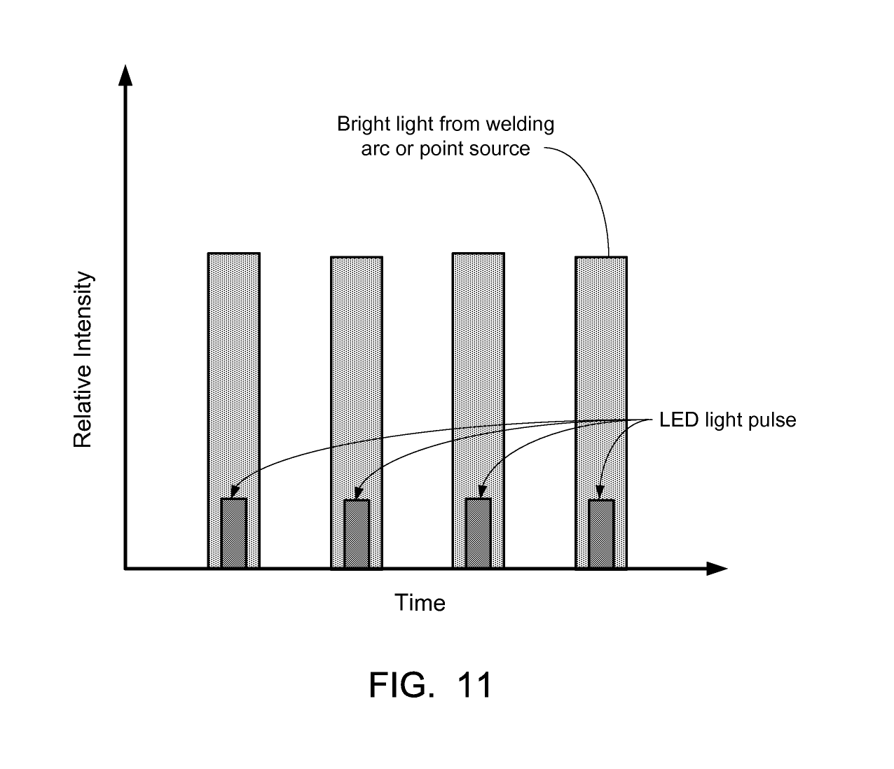

In one embodiment, the shutter from the camera and the LED lights are pulsed in synchronization to reduce the overall light entering the camera and to maximize the momentary brightness of the lights (see FIG. 11). In one embodiment of the present invention, the at least one LED light is not used to over-power the high intensity light, but rather augments the lighting of the surrounding structure. Illumination of the welding arc and weld pool is accomplished by using the light emitted by the welding process itself, but limiting those wavelengths of light which reach the camera to those within the bandwidth of the notch filter. A neutral density filter (or series of filters) can be used to lower the overall light level that reaches the camera. The neutral density filter can be in the form of uniform darkness across the filter, or a gradient filter having a darker central region and a lighter periphery region, or a combination of these two forms. This gradient filter can, in one embodiment, be created by a special application where the deposition rate of the neutral density filter coating is varied radially from the center of the filter to its periphery.

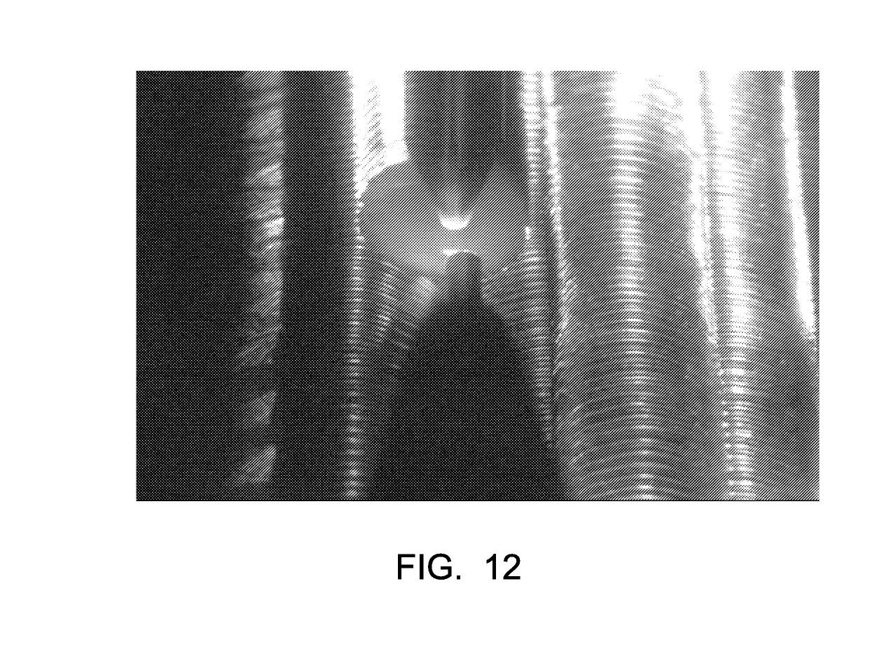

In another embodiment, in lieu of, or addition to, the neutral density filters, image filtering can also be accomplished through software where each video image pixel is filtered independently from the remaining pixels of the image. FIG. 12 is a photograph of a typical video image of a GTA welding operation using a Babcock & Wilcox/Weld Quality Control Camera.

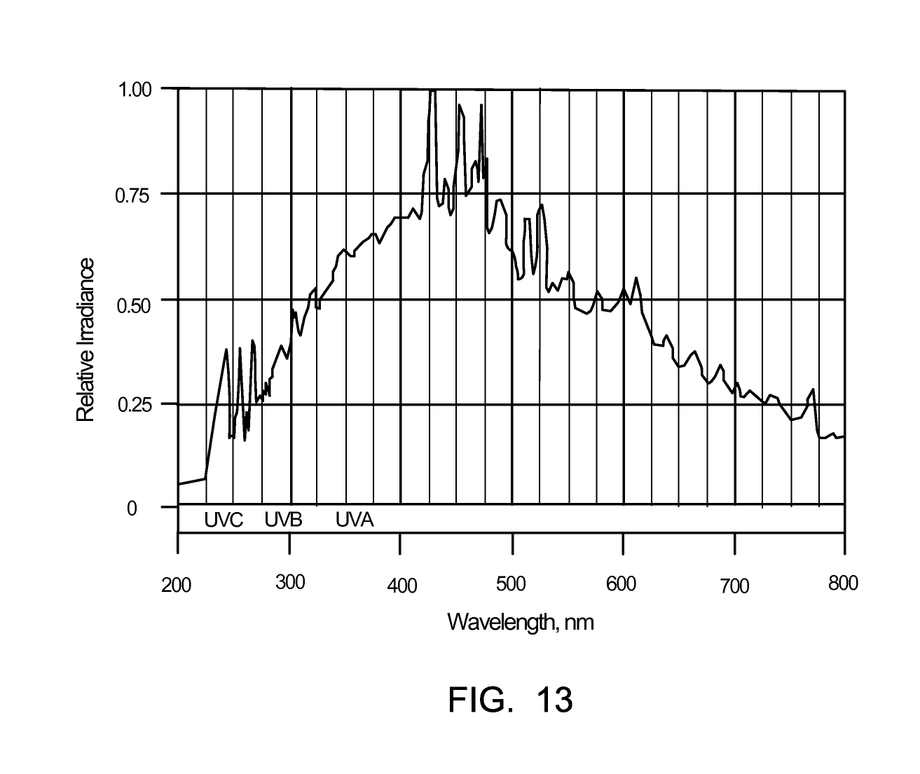

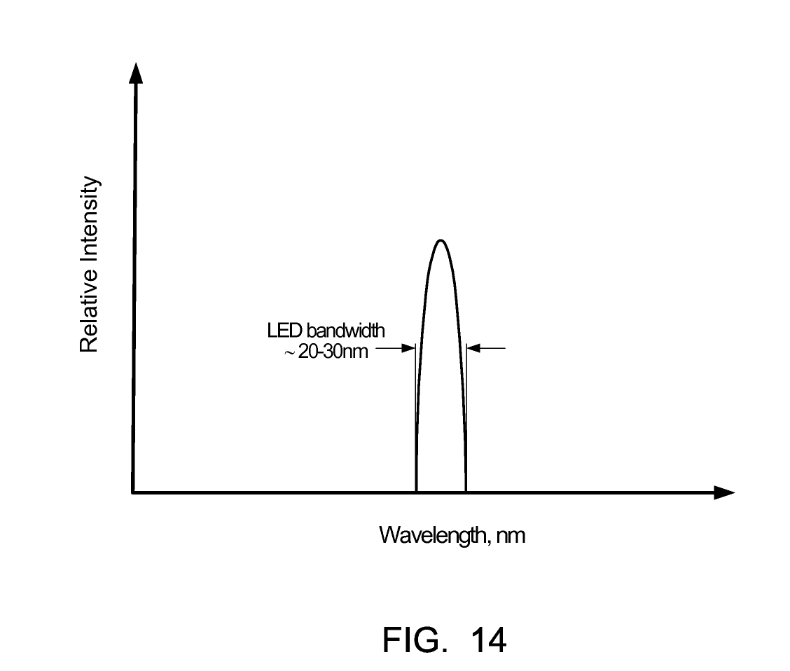

While not wishing to be bound to any one or more advantages, the visual monitoring, or imaging, system of the present invention is advantageous in that the at least one LED light source thereof is significantly less complex, more economical and safer than a laser-based or xenon flash lamp-based imaging system. A xenon flash lamp is a full spectrum light source (see FIG. 13) and the laser is a single wavelength device, while the at least one LED of the present invention are neither of these and make possible the generation of a specific bandwidth of spectral wavelengths (see FIG. 14).

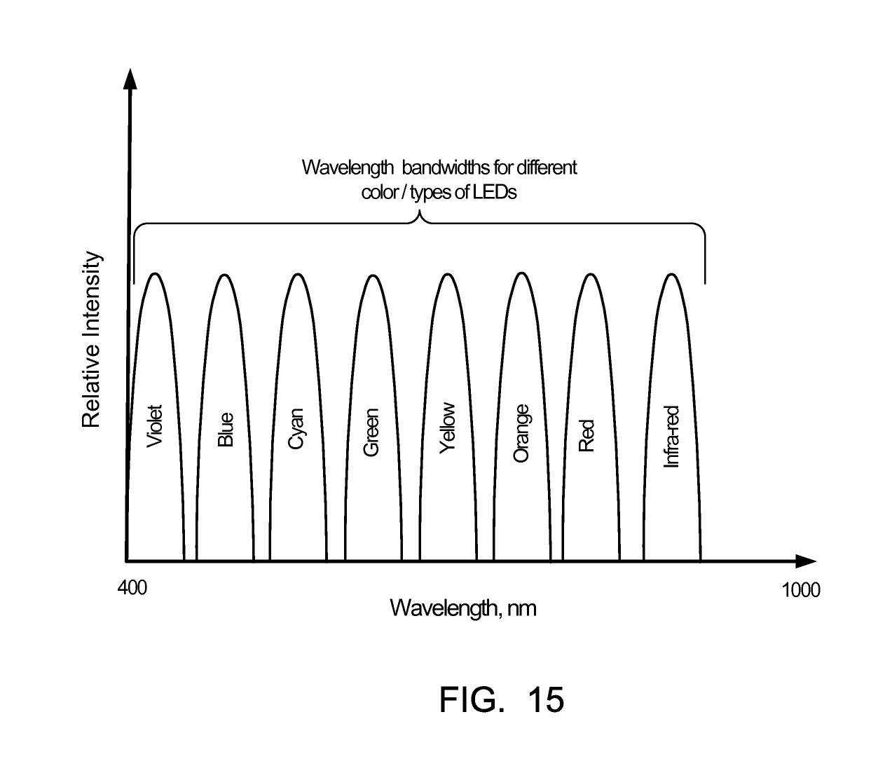

Another advantage of the visual monitoring, or imaging, system of the present invention is that it utilizes at least one tunable LED light source. Based upon the spectral analysis for a given application, the wavelength of the one or more LEDs of the present invention can be selected to best match the application for which visual monitoring, or imaging, is desired. Thus, the output wavelength of the one or more LEDs of the present invention is variable and can be tailored to be application dependent (see FIG. 15).

The one or more LED light sources of the present invention do not overpower the intense light from the plasma, flame, or welding arc. Thus, the output of the one or more LED lights of the present invention is/are significantly less than that for either the xenon flash lamp or laser systems of the prior art. As discussed above, in the present invention the one or more LED light sources is/are used to light the structure surrounding the point source. Accordingly, viewing of the point source is accomplished by using a narrow width notch filter and a neutral density filter and/or individual video pixel filtering.

As discussed above, the use of a laser or xenon flash lamp for illumination has several serious safety risks for the personnel operating the system. A laser in particular requires special shielding of the eyes and skin of the operator in order to protect against bodily damage. Any unplanned reflections of the beam must also be accounted for and protected against to prevent safety issues. While not as dangerous as a laser, a xenon flash lamp also has several serious safety issues that are due to the intensity of the xenon flash lamp. For example, eye and skin protection are required. In contrast, the relatively low power output of the one or more LEDs of the present invention present no personnel safety risks and do not require protective clothing or eyewear during operation.

While specific embodiments of the present invention have been shown and described in detail to illustrate the application and principles of the invention, it will be understood that it is not intended that the present invention be limited thereto and that the invention may be embodied otherwise without departing from such principles. In some embodiments of the invention, certain features of the invention may sometimes be used to advantage without a corresponding use of the other features. Accordingly, all such changes and embodiments properly fall within the scope of the following claims.

What is claimed is:

1. A visual monitoring, or imaging, system comprising:
at least one digital camera;
at least one light emitting diode light source; and
at least one filter, or multi-filter system.

2. The visual monitoring, or imaging, system of claim 1, wherein the at least one light emitting diode is selected from at least one infrared light emitting diode, at least one red light emitting diode, at least one orange light emitting diode, at least one yellow light emitting diode, at least one green light emitting diode, at least one blue light emitting diode, at least one violet light emitting diode, at least purple light emitting diode, at least one ultraviolet light emitting diode, at least one pink light emitting diode, at least one white light emitting diode, or a combination of any two or more thereof, any three or more thereof, any four or more thereof, any five or more thereof, any six or more thereof, or even any seven or more thereof.

3. The visual monitoring, or imaging, system of claim 1, wherein the at least one filter, or multi-filter system, is selected from at least one notch filter, at least one neutral density filter, or any combination of two or more thereof.

4. A method of imaging a work piece being subjected to an intense light source, the method comprising the step of:
using the system of claim 1 to image a work piece being subjected to an intense light source.

5. The method of claim 4, wherein the intense light source is the result of a plasma, flame, or welding arc process.

6. A visual monitoring, or imaging, system comprising:
at least one digital camera;
at least one light emitting diode light source;
at least one filter, or multi-filter system; and
image capturing, processing and/or collecting software.

7. The visual monitoring, or imaging, system of claim 6, wherein the at least one light emitting diode is selected from at least one infrared light emitting diode, at least one red light emitting diode, at least one orange light emitting diode, at least one yellow light emitting diode, at least one green light emitting diode, at least one blue light emitting diode, at least one violet light emitting diode, at least purple light emitting diode, at least one ultraviolet light emitting diode, at least one pink light emitting diode, at least one white light emitting diode, or a combination of any two or more thereof, any three or more thereof, any four or more thereof, any five or more thereof, any six or more thereof, or even any seven or more thereof.

8. The visual monitoring, or imaging, system of claim 6, wherein the at least one filter, or multi-filter system, is selected from at least one notch filter, at least one neutral density filter, or any combination of two or more thereof.

9. A method of imaging a work piece being subjected to an intense light source, the method comprising the step of:
using the system of claim 6 to image a work piece being subjected to an intense light source.

10. The method of claim 9, wherein the intense light source is the result of a plasma, flame, or welding arc process.

11. A visual monitoring, or imaging, system comprising:
at least one digital camera;
at least one light emitting diode light source;
at least one filter, or multi-filter system; and
image capturing, processing and/or collecting software that utilizes, in part, individual pixel filtering.

12. The visual monitoring, or imaging, system of claim 11, wherein the at least one light emitting diode is selected from at least one infrared light emitting diode, at least one red light emitting diode, at least one orange light emitting diode, at least one yellow light emitting diode, at least one green light emitting diode, at least one blue light emitting diode, at least one violet light emitting diode, at least purple light emitting diode, at least one ultraviolet light emitting diode, at least one pink light emitting diode, at least one white light emitting diode, or a combination of any two or more thereof, any three or more thereof, any four or more thereof, any five or more thereof, any six or more thereof, or even any seven or more thereof.

13. The visual monitoring, or imaging, system of claim 11, wherein the at least one filter, or multi-filter system, is selected from at least one notch filter, at least one neutral density filter, or any combination of two or more thereof.

14. A method of imaging a work piece being subjected to an intense light source, the method comprising the step of:
using the system of claim 11 to image a work piece being subjected to an intense light source.

15. The method of claim 14, wherein the intense light source is the result of a plasma, flame, or welding arc process.

16. A visual monitoring, or imaging, system as shown and described herein.

17. A method for visually monitoring, or imaging, a work piece using a visual monitoring, or imaging, system as shown and described herein.

18. A method for visually monitoring, or imaging, a work piece as shown and described herein.
